(19) United States
(12) Patent Application Publication
(10) Pub. No.: US 2022/0322161 A1
(43) Pub. Date: Oct. 6, 2022

(54) Handover of Group of Devices

(71) Applicants: Xiang XU, Jiangsu (CN); Vinh VAN PHAN, Oulu (FI); Ling YU, Kauniainen (FI)

(72) Inventors: Xiang XU, Jiangsu (CN); Vinh VAN PHAN, Oulu (FI); Ling YU, Kauniainen (FI)

(21) Appl. No.: 17/633,651

(22) PCT Filed: Aug. 14, 2019
(86) PCT No.: PCT/CN2019/100666

§ 371 Date: Feb. 8, 2022

(51) Int. Cl. H04W 36/00; H04W 36/32

(52) U.S. Cl. CPC H04W 36/0009; H04W 36/32

(57) ABSTRACT

Example embodiments of the present disclosure relate to a solution for handing over a group of devices. In an aspect, a first device transmits, to a second device, first information of a group of devices. The first device receives, from the second device, second information associated with a target handover configuration for the group of devices. The first device adjusts, based on the second information, a movement of the group of devices to enable the group of devices to be handed over based on the target handover configuration. With example embodiments of the present disclosure, a group of devices (such as, a swarm of UAVs) moving based on a movement pattern can be effectively and efficiently handed over from a serving cell to another serving cell, for example, in the UAV application scenario or the V2X application scenarios, or the like.

### FIELD

Example embodiments of the present disclosure generally relate to the field of communication, and in particular to devices, methods, apparatuses and a computer readable medium for handing over a group of devices.

### BACKGROUND

In some communication scenarios, a group of devices, such as a plurality of unmanned aerial vehicles (UAVs) can move in an organized swarm. That is, the group of devices may move based on the same movement pattern (also termed as a mobility pattern) or the same movement route. In these communication scenarios, the mobility performance of the group of devices in a communication network may be affected due to the relative large number of the devices in the group.

In practice, a swarm of UAVs is capable of accomplishing a task that one UAV either fulfils with difficulty, such as accurate determination of the location for an object, or fails to accomplish altogether. There are many different types of usage scenarios for a swarm of UAVs. For example, by using a swarm of UAVs consisting of 100 UAVs to perform a complex aerial dance, three dimensional (3D) wireframe pictures of abstract shapes, moving images, and even words in constantly shifting colors can be shown. Typically, these UAVs are moving with a preconfigured movement pattern.

### SUMMARY

In general, example embodiments of the present disclosure provide a solution for handing over a group of devices.

In a first aspect, there is provided a first device. The first device comprises at least one processor and at least one memory storing computer program codes. The at least one memory and the computer program codes are configured, with the at least one processor, to cause the first device to transmit, to a second device, first information of a group of devices. The at least one memory and the computer program codes are also configured, with the at least one processor, to cause the first device to receive, from the second device, second information associated with a target handover configuration for the group of devices. The at least one memory and the computer program codes are further configured, with the at least one processor, to cause the first device to adjust, based on the second information, a movement of the group of devices to enable the group of devices to be handed over based on the target handover configuration.

In a second aspect, there is provided a second device. The second device comprises at least one processor and at least one memory storing computer program codes. The at least one memory and the computer program codes are configured, with the at least one processor, to cause the second device to transmit, to a third device, a handover request associated with a group of devices to be handed over from the second device to the third device. The handover request comprises at least one of first information of the group of devices or a requested handover configuration for the group of devices. The at least one memory and the computer program codes are also configured, with the at least one processor, to cause the second device to receive, from the third device, an indication of a target handover configuration for the group of devices. The at least one memory and the computer program codes are further configured, with the at least one processor, to cause the second device to transmit, to a first device associated with the group of devices, second information associated with the target handover configuration, for adjusting a movement of the group of devices to enable the group of devices to be handed over based on the target handover configuration.

In a third aspect, there is provided a third device. The third device comprises at least one processor and at least one memory storing computer program codes. The at least one memory and the computer program codes are configured, with the at least one processor, to cause the third device to receive, from a second device, a handover request associated with a group of devices to be handed over from the second device to the third device. The handover request comprises at least one of first information of the group of devices or a requested handover configuration for the group of devices. The at least one memory and the computer program codes are also configured, with the at least one processor, to cause the third device to determine, based on an available handover capacity of the third device, a target handover configuration for the group of devices. The at least one memory and the computer program codes are further configured, with the at least one processor, to cause the third device to transmit, to the second device, an indication of the target handover configuration to enable the group of devices to be handed over based on the target handover configuration.

In a fourth aspect, there is provided a method. The method comprises transmitting, at a first device to a second device, first information of a group of devices. The method also comprises receiving, from the second device, second information associated with a target handover configuration for the group of devices. The method further comprises adjusting, based on the second information, a movement of the group of devices to enable the group of devices to be handed over based on the target handover configuration.

In a fifth aspect, there is provided a method. The method comprises transmitting, at a second device to a third device, a handover request associated with a group of devices to be handed over from the second device to the third device. The handover request comprises at least one of first information of the group of devices or a requested handover configuration for the group of devices. The method also comprises receiving, from the third device, an indication of a target handover configuration for the group of devices. The method further comprises transmitting, to a first device associated with the group of devices, second information associated with the target handover configuration, for adjusting a movement of the group of devices to enable the group of devices to be handed over based on the target handover configuration.

In a sixth aspect, there is provided a method. The method comprises receiving, at a third device from a second device, a handover request associated with a group of devices to be handed over from the second device to the third device. The handover request comprises at least one of first information of the group of devices or a requested handover configuration for the group of devices. The method also comprises determining, based on an available handover capacity of the third device, a target handover configuration for the group of devices. The method further comprises transmitting, to the second device, an indication of the target handover configuration to enable the group of devices to be handed over based on the target handover configuration.

In a seventh aspect, there is provided an apparatus. The apparatus comprises means for transmitting, at a first device to a second device, first information of a group of devices. The apparatus also comprises means for receiving, from the second device, second information associated with a target handover configuration for the group of devices. The apparatus further comprises means for adjusting, based on the second information, a movement of the group of devices to enable the group of devices to be handed over based on the target handover configuration.

In an eighth aspect, there is provided an apparatus. The apparatus comprises means for transmitting, at a second device to a third device, a handover request associated with a group of devices to be handed over from the second device to the third device. The handover request comprises at least one of first information of the group of devices or a requested handover configuration for the group of devices. The apparatus also comprises means for receiving, from the third device, an indication of a target handover configuration for the group of devices. The apparatus further comprises means for transmitting, to a first device associated with the group of devices, second information associated with the target handover configuration, for adjusting a movement of the group of devices to enable the group of devices to be handed over based on the target handover configuration.

In a ninth aspect, there is provided an apparatus. The apparatus comprises means for receiving, at a third device from a second device, a handover request associated with a group of devices to be handed over from the second device to the third device. The handover request comprises at least one of first information of the group of devices or a requested handover configuration for the group of devices. The apparatus also comprises means for determining, based on an available handover capacity of the third device, a target handover configuration for the group of devices. The apparatus further comprises means for transmitting, to the second device, an indication of the target handover configuration to enable the group of devices to be handed over based on the target handover configuration.

In a tenth aspect, there is provided a non-transitory computer readable medium storing program instructions for causing an apparatus to perform at least the method according to the fourth, fifth, or sixth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates a schematic diagram of a communication environment in which some example embodiments of the present disclosure can be implemented;

FIG. 2 illustrates an example communication process among a first device, a second device, and a third device in accordance with some example embodiments of the present disclosure;

FIG. 3 illustrates a flowchart of an example method in accordance with some example embodiments of the present disclosure;

FIG. 4 illustrates a flowchart of another example method in accordance with some example embodiments of the present disclosure;

FIG. 5 illustrates a flowchart of another example method in accordance with some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every example embodiment includes the particular feature, structure, or characteristic. Moreover, such phrases are not necessarily referring to the same example embodiment. Further, when a particular feature, structure, or characteristic is described in connection with an example embodiment, it is submitted that it is within the knowledge of one skilled in the art to affect such feature, structure, or characteristic in connection with other example embodiments whether or not explicitly described.

It shall be understood that although the terms “first” and “second” or the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular example embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, components and/or the like, but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Example embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a UAV, a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned, there are many different types of usage scenarios for a group of devices, such as, a swarm of UAVs. However, due to the characteristics of the group of devices, it is preferred that all the devices of the group are handled in such way that any network operations are performed successfully for all the devices in the group. Otherwise, the group may not be fully functional if one device in the group has failed in a certain network operation. For example, a successful handover of all the devices of a group needs to be considered under the mobility of the group. The group, especially a swarm, may not function normally even if one device in the group has experienced a handover failure. For example, in the case that a target network device does not support the handover of all the devices of a group simultaneously, the issue of how to hand over the group of devices to the target network device needs to be solved in order to ensure all the devices of the group can be handed over to the target network device.

There are some traditional schemes for handover of a group of devices. However, these traditional schemes mainly focus on how to handle the devices as a group in order to save the signaling overhead encountered during the group handover. An obvious and essential difference is that mobility of devices in the traditional schemes is usually tied to human users and vehicles on the road, which cannot be flexibly controlled to reform with different patterns on the fly. In other words, the traditional schemes do not consider the flexible movement capability in the handover of a group of devices.

In view of the above problems and other potential problems in the traditional solutions, example embodiments of the present disclosure provide a solution for handing over a group of devices, especially a swarm of UAVs. In contrast to the traditional schemes, a group of devices in embodiments of the present disclosure, such as a swarm of UAVs, may be fully controllable moving (for example, flying) devices. The movement (such as, a movement pattern) of the group of devices can be adjusted or slowed down based on the handover configuration and/or capability of the target network device.

With example embodiments of the present disclosure, a group of devices (such as, a swarm of UAVs) moving based on a movement pattern can be effectively and efficiently handed over from a serving cell to another serving cell, for example, in the UAV application scenario or the vehicle to everything (V2X) application scenario, or the like. Principles and implementations of example embodiments of the present disclosure will be described in detail below with reference to the figures.

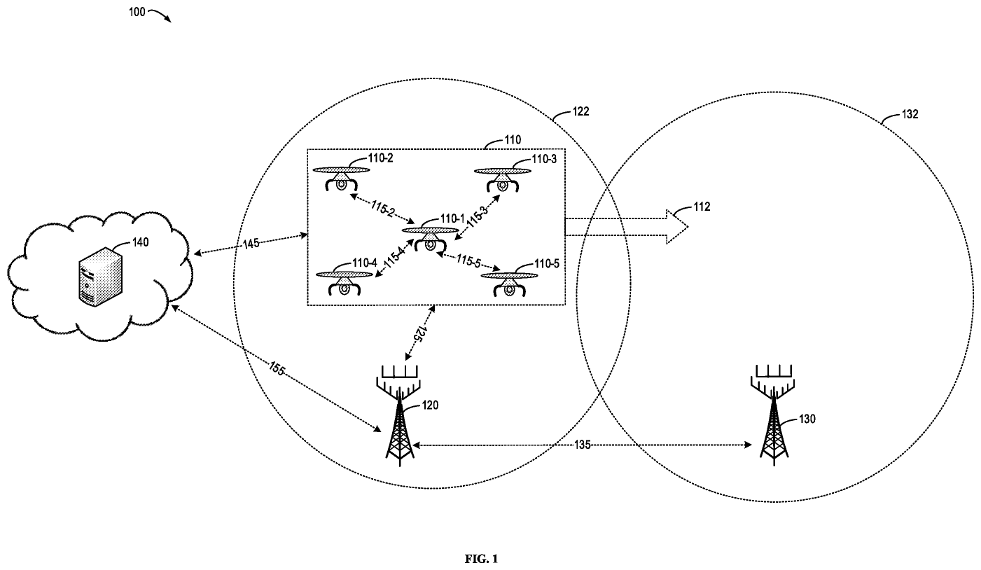

FIG. 1 illustrates a schematic diagram of a communication environment 100 in which some example embodiments of the present disclosure can be implemented. The communication environment 100 may include a group of devices 110, which is formed by a device 110-1, a device 110-2, a device 110-3, a device 110-4, and a device 110-5. It is to be understood that the specific number (5) of devices in the group here is only for the purpose of illustration, without suggesting any limitation as to the scope of the disclosure. In other example embodiments, the group of devices 110 can be formed by any suitable number of devices. Among the devices 110-1 to 110-5, the device 110-1 can be a leader device of the group of devices 110, and may be referred to as a first device 110-1 in the following for ease of description.

As used herein, the leader device may refer to one device of the group of devices 110, which can gather information from other devices in the group of devices 110. For example, the first device 110-1 as the leader device can receive information of the device 110-2 via a communication link 115-2, information of the device 110-3 via a communication link 115-3, information of the device 110-4 via a communication link 115-4, and information of the device 110-5 via a communication link 115-5. In some example embodiments, the communication links 115-2 to 115-5 and other possible communication links between any two devices in the group of devices 110 may include device-to-device (D2D) links (also referred to as sidelinks), cellular links, or other suitable links which enable the communications among the devices 110-1 to 110-5.

In addition, the first device 110-1 as the leader device can transmit a control signal to any one of the other devices in the group of devices 110 to control the movement of the device. For example, the first device 110-1 may transmit a control signal to the device 110-2 via the communication link 115-2 to control the movement of the device 110-2, transmit a control signal to the device 110-3 via the communication link 115-3 to control the movement of the device 110-3, transmit a control signal to the device 110-4 via the communication link 115-4 to control the movement of the device 110-4, and transmit a control signal to the device 110-5 via the communication link 115-5 to control the movement of the device 110-5.

Moreover, the first device 110-1 as the leader device can be in charge to communicate with a second device 120, which may provide wireless connections for the group of devices 110 located in a cell 122 of the second device 120. As shown, the first device 110-1 may communicate with the second device 120 via a communication link 125, such as a wireless communication channel. For example, the first device 110-1 can transmit information of the group of devices 110 to the second device 120 via the communication link 125, such as an uplink wireless communication channel, so that the second device 120 can better serve the group of devices 110. The information of the group of devices 110 may include any possible information related to the group of devices 110 or to the movement of the group of devices 110, and the like.

In addition, the second device 120 can transmit control or configuration information for the group of devices 110 to the first device 110-1 via the communication link 125, such as a downlink wireless communication channel. Upon receiving the control or configuration information, the first device 110-1 can transmit one or more control signals to one or more other devices of the group of devices 110 to configure or control them according to the control or configuration information received from the second device 120. For example, the first device 110-1 can configure or adjust the movement of any device of the group of devices 110.

In a similar way to that the first device 110-1 communicates with the second device 120, any device of the group of devices 110 can communicate with the second device 120. In this event, the communication link 125 can generally represent a plurality of communication links between the devices of the group of devices 110 and the second device 120, for example, including a communication link between the device 110-2 and the second device 120, a communication link between the device 110-3 and the second device 120, a communication link between the device 110-4 and the second device 120, and a communication link between the device 110-5 and the second device 120.

As an example purpose of these communication links between the devices of the group of devices 110 and the second device 120, the second device 120 can schedule transmission resource allocation for the D2D link communications between the first device 110-1 and member devices (the devices 110-2 to 110-5) of the group of devices 110. In the case that the second device 120 can communicate directly with the first device 110-1 as well as the devices 110-2 to 110-5, the second device 120 may transmit control signals to the individual devices of the group of devices 110 to control movements of these individual devices, instead of controlling the movements of the devices through the first device 110-1 as the leader device.

In some example embodiments, all or part of the operations performed by the first device 110-1 as the leader device can be alternatively performed by a server 140, such as an application server, for controlling the movement of the group of devices 110. For example, the server 140 can transmit the information of the group of devices 110 to the second device 120 via a communication link 155, which may include various communication networks, wired communication channels, wireless communication channels, or the like. Also, the server 140 can receive control or configuration information from the second device 120 via the communication link 155.

In addition, the server 140 can transmit control signals to one or more of the devices 110-1 to 110-5 to control their movements. As shown, the control signals can be transmitted via a communication link 145, which may also include various communication networks, wired communication channels, wireless communication channels, or the like. In the case that the second device 120 can communicate directly with the first device 110-1 as well as the devices 110-2 to 110-5, the second device 120 may transmit control signals to the individual devices of the group of devices 110 to control movements of these devices, instead of controlling the movements of the devices through the server 140.

In the example scenario of FIG. 1, the group of devices 110 is moving along a movement path 112. This means that the group of devices 110 is to be out of the cell 122 of the second device 120 and to enter into a cell 132 of a third device 130, which may be a neighboring network device of the second device 120. Therefore, the second device 120 may need to hand over the group of devices 110 to the third device 130. To this end, the second device 120 can communicate information related to the handover of the group of devices 110 with the third device 130 via a communication link 135. In some example embodiments, the communication link 135 may include various interfaces between two network devices, such as an X2 interface, an Xn interface, or any other suitable existing or future interfaces enabling communications between two network devices. In another example, the communication link 135 may be an indirect interface, such as, the communication between the second device 120 and the third device 130 may traverse another device using a S1 interface, a NG interface, or any other suitable existing or future interfaces enabling communications between two network devices via another device.

In some example embodiments, the group of devices 110 may include a swarm of terminal devices, for example, a swarm of UAVs. In some other example embodiments, the group of devices 110 may alternatively include a group of any existing or future mobile devices. In some example embodiments, the second and third devices 120 and 130 may be network devices. In this event, for the group of devices 110, the second device 120 may also be termed as a serving RAN node, and the third device 130 may also be referred to as a neighboring RAN node or a target RAN node in the case of handover. More generally, the group of devices 110, the second device 120, and the third device 130 may be any other suitable communication devices, which can communicate with one another. Example embodiments of the present disclosure are not limited to the example scenario of FIG. 1. In this regard, it is noted that although group of devices 110 are schematically depicted as a swarm of UAVs and the second and third devices 120 and 130 are schematically depicted as base stations in FIG. 1, it is understood that this depiction is only for example without suggesting any limitation.

It is to be understood that the number of communication devices, the number of communication channels, and the number of other elements as shown in FIG. 1 are only for the purpose of illustration without suggesting any limitations. The communication environment 100 may include any suitable number of communication devices, any suitable number of communication channels, and any suitable number of other elements adapted for implementing example embodiments of the present disclosure. Although not shown, it would be appreciated that all the devices and other function entities may belong to and be located in the same communication network or different communication networks.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

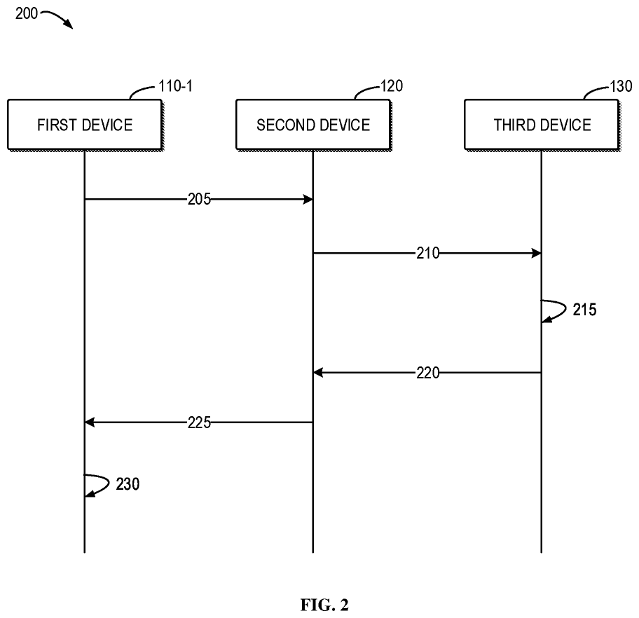

Reference is now made to FIG. 2, which illustrates an example communication process 200 among the first device 110-1, the second device 120, and the third device 130 in accordance with some example embodiments of the present disclosure. For the purpose of discussion, the communication process 200 will be described with reference to FIG. 1. However, it would be appreciated that the communication process 200 may be equally applicable to other communication scenarios where a group of devices is handed over from a serving cell to another serving cell. In addition, the operations performed by the first device 110-1 during the communication process 200 can be alternatively operated by the server 140.

As shown in FIG. 2, the first device 110-1 transmits 205 information of the group of devices 110 to the second device 120. For ease of description, this information of the group of devices 110 may be referred to as first information in the following. As used herein, the first information can also be referred to as group information of the group of devices 110, or swarm information in the case that the group of devices 110 is a swarm of UAVs.

The first information may be transmitted by the first device 110-1 to the second device 120 for various purposes. For example, when the group of devices 110 is to move out of the cell 122 of the second device 120 and to enter into the cell 132 of the third device 130, the second device 120 may need to hand over the group of devices 110 to the third device 130. Due to this handover, the first device 110-1 may transmit the first information to the second device 120, so that the second device 120 and the third device 130 can complete the handover according to the characteristics of the group of devices 110 provided in the first information. As another example, when serving the group of devices 110, the second device 120 may also receive the first information from the first device 110-1. Then, the second device 120 can provide a better service to the group of devices 110 based on the characteristics of the group of devices 110 provided in the first information.

In some example embodiments, the first information may include various kinds of information related to the group of devices 110. For example, the first information may include the number of devices in the group of devices 110, so that the second device 120 (and/or the third device 130) may determine whether all the devices in the group of devices 110 can be handed over simultaneously. Additionally or alternatively, the first information may include a movement speed of a device in the group of devices, such as, the maximum speed of a device, so that the second device 120 (and/or the third device 130) may calculate the time limit for handing over the device, the time period to serve the group of devices 110 before the next handover, and so on.

Additionally or alternatively, the first information may include a movement direction of a device in the group of devices, so that the second device 120 (and/or the third device 130) may calculate the time point for handing over the device. Additionally or alternatively, the first information may include a quality of service (QoS) requirement, a degraded QoS requirement, or a lowest QoS requirement of a device in the group of devices, so that the second device 120 (and/or the third device 130) may guarantee the QoS requirement for an individual device in the group of devices 110 during the handover.

Additionally or alternatively, the first information may include a total QoS requirement, a degraded total QoS requirement, or a lowest total QoS requirement of the group of devices, so that the second device 120 (and/or the third device 130) may guarantee the QoS requirement for the group of devices 110 as a whole during the handover. Additionally or alternatively, the first information may include relevant information of a communication link between a device of the group of devices and the second device 120, for example, a link identity (ID), a link configuration, or the like, so that the second device 120 (and/or the third device 130) can guarantee the continuity of the communication link during the handover. More generally, the first information may include any other information that may affect serving the group of devices 110 and the handover of the group of devices 110.

As shown in FIG. 1, the first device 110-1 can transmit the first information of the group of devices 110 to the second device 120 via the communication link 125, such as a wireless uplink channel from the first device 110-1 to the second device 120, for example, using a radio resource control (RRC) message. As an alternative to the first device 110-1, the server 140 can transmit the first information of the group of devices 110 to the second device 120 via the communication link 155, for example, via an interface used for MEC (Mobile Edge Computing, or Multi-access Edge Computing) purpose, which enables the server 140 to be deployed close to the radio access network.

During the movement of the group of devices 110 along the movement path 112, the second device 120 as the serving device can determine that the group of devices 110 is to be handed over to the third device 130. For example, the second device 120 may predict the movement path 112 to be travelled by the group of devices 110 based on the first information received from the first device 110-1, which may include information of the movement direction of the group of devices 110, for example. Then, the second device 120 may determine that the third device 130 is to become the serving device of the group of devices 110 based on the predicted movement path 112.

For example, based on the movement information of the group of devices 110, the second device 120 can know that the group of devices 110 is moving into the cell 132 of the third device 130, and thus may need to be handed over to the third device 130. As such, the second device 120 may accurately determine the target serving device for the group of devices 110. In another example embodiment, the second device 120 may determine that the third device 130 is to become the serving device of the group of devices 110 based on a measurement report from at least one of the devices of the group of devices 110. In another example embodiment, the second device 120 may determine that the third device 130 is to become the serving device of the group of devices 110 based on a measurement report from at least one of the devices of the group of devices 110, and the information of the group of devices 110.

Accordingly, for the handover of the group of devices 110, the second device 120 transmits 210 a handover request associated with the group of devices 110 to the third device 130, for example, via a handover request message. In some embodiments, the handover request may be transmitted from the second device 120 to the third device 130 via the communication link 135, for example, an X2 interface or an Xn interface. In the case of next generation (NG)-based (or N2-based) handover without an Xn interface, the handover request may be transmitted through an access and mobility management function (AMF) device.

In some example embodiments, the handover request may include the first information of the group of devices 110. As described above, the second device 120 may receive the first information from the first device 110-1. In this way, the first information obtained by the second device 120 may be the latest information of the group of devices 110. Then, based on the first information, the second device 120 can determine the requested handover configuration, which may be used to request the third device 130 to employ such a requested handover configuration in the handover of the group of devices 110. In one example embodiment, the requested handover configuration may indicate the requested number of devices to be handed over within a predefined time interval with a required QoS. Alternatively, the requested handover configuration may include a list of items, which each item indicates the requested number of devices to be handed over within a predefined time interval with a required QoS or an alternative QoS. Therefore, in addition to or in alternative to the first information of the group of devices 110, the handover request may include the requested handover configuration for the group of devices 110. As such, a handover configuration suitable for the current movement of the group of devices 110 can be determined by the second device 120 as the requested handover configuration.

In another example embodiment, the second device 120 can determine and transmit a plurality of requested handover configurations to the third device 130. The third device 130 may then select one of the requested handover configurations for the handover of the group of devices 110.

In some example embodiments, the requested handover configuration can include various parameters related to the handover of the group of devices 110. For example, the requested handover configuration can indicate the maximum or minimum number of devices to be handed over within a predefined time interval with the minimum QoS requirement, which may also be termed herein as a required handover rate. After obtaining the first information and the requested handover configuration, the second device 120 can generate the handover request to include the first information, the requested handover configuration or both of them, and then transmit 210 the handover request to the third device 130. In the case of next generation (NG)-based (or N2-based) handover without an Xn interface, the information of the group of devices and the requested handover configuration may be transmitted through an access and mobility management function (AMF) device, for example, via a container that is transparent to the AMF device.

After receiving 210 the handover request from the second device 120, the third device 130 can obtain the information of the group of devices 110 and/or the requested handover configuration from the handover request. Then, the third device 130 determines 215 a target handover configuration for the group of devices 110 based on an available handover capacity of the third device, for example, a handover capability and/or a current handover capacity and/or an operation state, and/or the like of the third device 130. For example, the target handover configuration may be a handover configuration currently supported and accepted by the third device 130. Thus, the third device 130 can determine the target handover configuration according to a handover capacity, an operation state, a workload, or the like of the third device 130.

Further, in the case of a centralized unit (CU)-distributed unit (DU) split architecture, the CU in the third device 130 may transmit the whole or part of the first information and/or the requested handover configuration to the DU in the third device 130. The DU may determine a DU-related handover configuration for the group of devices 110 based on the first information of the group of devices 110 and/or its own capability and/or capacity and/or operation state, and/or the like. The DU then provides the DU-related handover configuration to the CU to assist the CU to generate the target handover configuration.

In some example embodiments, the target handover configuration may indicate the number of devices to be handed over within a predefined time interval with an acceptable QoS, which can also be termed herein as a target handover rate. With such information provided by the target handover configuration, it is more convenient for the first device 110-1 (or the server 140) to adjust the movement of the group of devices 110 according to the target handover configuration. Additionally or alternatively, the target handover configuration may include the allowed numbers of devices that can be handed over to the third device 130 in different time windows. For example, the target handover configuration may indicate that ten (10) devices can be handed over in the first five (5) seconds, and twenty (20) devices can be handed over in the next five (5) seconds, and so on. More generally, the target handover configuration can include any other handover parameters that may affect the handover of the group of devices 110.

In order to enable the group of devices 110 to be handed over based on the target handover configuration, the third device 130 transmits 220 an indication of the target handover configuration to the second device 120. In some example embodiments, the indication of the target handover configuration may be transmitted from the third device 130 to the second device 120 via the communication link 135, such as an X2 interface or an Xn interface, using an acknowledge message for the handover request from the second device 120. In the case of NG-based handover without an Xn interface, the indication of the target handover configuration may be transmitted through an AMF device, for example, via a container that is transparent to the AMF device.

The indication of the target handover configuration provided by the third device 130 to the second device 120 can be based on the first information of the group of devices 110 and/or the requested handover configuration from the second device 120. In other words, depending on the first information of the group of the devices 110 and/or the requested handover configuration provided by the second device 120, the third device 130 may transmit the indication of the target handover configuration in different manners.

For example, if the third device 130 can fulfil the requested handover as indicated by the information of the group of devices 110 and/or the requested handover configuration provided by the second device 120, the third device 130 may transmit an acknowledgement indication to the second device 120. The acknowledgement indication may indicate that the requested handover is accepted by the third device 130. This means that the third device 130 fully accepts the handover request from the second device 120. That is, the third device 130 can fully support the handover of all the devices of the group of devices 110. For example, the requested handover rate and the related QoS requirements can be accepted by the third device 130. With the acknowledgement indication which may be represented, for example, by only one bit, the transmission resources for transmitting the indication of the target handover configuration can be saved.

Alternatively, if the third device 130 cannot fulfil the requested handover as indicated by the information of the group of devices 110 and/or the requested handover configuration provided by the second device 120, the third device 130 may transmit an explicit indication of the target handover configuration. This means that the third device 130 does not accept the requested handover request from the second device 120. For example, the third device 130 is busy and cannot support the requested handover rate of the group of devices 110, or other requested handover parameters, or the like. As another example, the third device 130 may support some requested handover parameters indicated in the requested handover configuration from the second device 120, but with a degraded QoS or a degraded level of a certain handover parameter. This means that the third device 130 only partially accepts the requested handover request. In this case, the third device 130 also transmits the explicit indication of the target handover configuration to the second device 120. With the explicit indication, the target handover configuration can be determined in a more straightforward way.

In both cases of the acknowledgement indication and the explicit indication, the third device 130 may transmit to the second device 120 a handover request acknowledge message including the target handover configuration, which may indicate that the handover request from the second device 120 is fully accepted by the third device 130, not accepted by the third device 130, or partially accepted by the third device 130. In another example embodiment, there may be an information element (IE) in the handover request acknowledge message, indicating whether the requested handover is fully accepted, partially accepted, or not accepted by the third device 130.

In addition, as mentioned above, the second device 120 may transmit a plurality of requested handover configurations and each of the requested handover configurations may correspond to one movement pattern of the group of devices 110. In this event, the third device 130 may accept one of the requested handover configurations as the target handover configuration and indicate it to the second device 120. In some other example embodiments, the target handover configuration determined by the third device 130 may be different from any of the plurality of requested handover configurations.

From the perspective of the second device 120 as a receiving device of the indication, the second device 120 may receive at least one of the acknowledgement indication or the explicit indication. In the case of the acknowledgement indication, the second device 120 may determine that the requested handover configuration, which is determined by itself, is accepted by the third device 130 as the target handover configuration, and/or the third device 130 can fulfil the requested handover as indicated by the information of the group of devices 110.

Alternatively, in the case of the explicit indication, the second device 120 can know that the target handover configuration determined by the third device 130 is different from the requested handover configuration, and/or the third device 130 cannot fulfil the requested handover as indicated by the information of the group of devices 110. The second device 120 can thus obtain the target handover configuration from the explicit indication.

In addition, there may be some scenarios in which the second device 120 receives both the acknowledgement indication and the explicit indication from the third device 130. For example, the third device 130 may transmit an indication to the second device 120. The indication may include an IE indicating that the requested handover is accepted, and the target handover configuration for a part of the group of devices 110. Especially, if the requested handover configuration from the second device 120 is a list like {10 UEs with QoS1, 20 UEs with QoS2, and so on}, and then the third device 130 may just select one of the handover configurations in the list. In this event, the third device 130 may transmit both the acknowledgement indication and the explicit indication to the second device 120.

In the case that the third device 130 does not accept or only partially accepts the handover request from the second device 120, the third device 130 may provide an update of the handover configuration to the second device 120, if the handover configuration supported and accepted by the third device 130 is changed. Thus, in some example embodiments, the third device 130 may transmit a plurality of indications to the second device 120. The plurality of indications may indicate a plurality of handover configurations supported by the third device 130 at different time points. Accordingly, the second device 120 may receive the plurality of indications from the third device 130, and then select the indication of the target handover configuration from the plurality of indications.

It is noted that the last indication of the plurality of indications indicates the handover configuration which is most recently updated by the third device 130, namely, the handover configuration supported by the third device 130 at a latest time point. Therefore, the second device 120 can select the last indication as the indication of the target handover configuration. In this manner, the third device 130 can inform the second device 120 of the latest handover configuration that is supported and accepted by the third device 130.

After receiving 220 the indication of the target handover configuration from the third device 130, the second device 120 transmits 225 to the first device 110-1 information associated with the target handover configuration. For ease of description, this information transmitted to the first device 110-1 (or the server 140) and associated with the target handover configuration may be referred to as second information. In one example, the second information may contain the information of the target handover configuration. The second information may be used for adjusting the movement of the group of devices 110, so that the group of devices 110 can be handed over based on the target handover configuration indicated by the second information.

In some example embodiments, the second information may be transmitted from the second device 120 to the first device 110-1 via the communication link 125, such as a wireless downlink channel from the second device 120 to the first device 110-1. Additionally, the second information may be transmitted from the second device 120 to any one of the group of devices 110 via the communication link 125, such as a wireless downlink channel from the second device 120 to a device (for example, the device 110-2, 110-3, 110-4, or 110-5) of the group of devices 110. Alternatively, the second device 120 can transmit the second information to the server 140 via the communication link 155.

Depending on which device controls the movement of the group of devices 110, the second device 120 may transmit different second information to the first device 110-1 or the server 140. For example, if the movements of individual devices of the group of devices 110 can be directly controlled by the second device 120, the second device 120 may transmit adjusting information to the first device 110-1, to adjust a movement of the first device 110-1 based on the target handover configuration. More particularly, a movement speed of the first device 110-1, a movement direction of the first device 110-1, and a relative position of the first device 110-1 in the group of devices 110, or the like can be adjusted via the adjusting information. In a similar way, the second device 120 can adjust a movement of any other device of the group of devices 110 via similar adjusting information.

Alternatively, if the movements of individual devices of the group of devices 110 are controlled by the first device 110-1 or the server 140, the second device 120 may transmit an indication of the target handover configuration to the first device 110-1 or the server 140, such that the first device 110-1 or the server 140 can adjust the movement of the group of devices 110 based on the target handover configuration. For example, the first device 110-1 or the server 140 may further communicate with one or more devices of the group of devices 110 to adjust the movement of the one or more devices.

Accordingly, upon receiving 225 the second information from the second device 120, the first device 110-1 can adjust 230 the movement of the group of devices 110 based on the second information. Through this adjustment, the group of devices 110 can be handed over from the second device 120 to the third device 130 based on the target handover configuration.

For example, as mentioned above, if the second device 120 can directly control the movements of individual devices of the group of devices 110, the first device 110-1 may receive adjusting information from the second device 120. According to the adjusting information, the first device 110-1 may adjust its movement, such as, a movement speed of the first device 110-1, a movement direction of the first device 110-1, and a relative position of the first device 110-1 in the group of devices 110, or the like. Similarly, the movements of other devices of the group of devices 110 may be adjusted by the second device 120 via similar adjusting information. In this way, the movement of the group of devices 110 can be directly adjusted by the second device 120, without the assistance from the first device 110 as the leader device or from the sever 140.

Alternatively, as mentioned above, if the first device 110-1 or the server 140 controls the movements of individual devices of the group of devices 110, the first device 110-1 or the server 140 may receive an indication of the target handover configuration from the second device 120. In this event, the first device 110-1 or the server 140 can transmit further information to one or more devices of the group of devices 110 to adjust the movement of the group of devices 110. For ease of description, this further information transmitted from the first device 110-1 (or the server 140) to the group of devices 110 for adjusting the movement of the group of devices 110 may be referred to as third information. In some example embodiments, the third information may be transmitted via one or more of the communication links 115-2, 115-3, 115-4, and 115-5. Alternatively, the server 140 can transmit the third information to one or more of the group of devices 110 via the communication link 145.

Through the third information, the first device 110-1 (or the server 140) may adjust movements of individual devices of the group of devices 110 based on the target handover configuration, so that the group of devices 110 can be handed over to the third device 130 according to the target handover configuration that is supported and accepted by the third device 130. In this way, it is unnecessary for the second device 120 to communicate with each of the group of devices 110, and thus various communications between the second device 120 and the individual devices of the group of devices 110 for the purpose of adjusting their movements can be avoided.

As a particular example, it is assumed that the third device 130 accepts the handover request from the second device 120 with the configuration defined by the target handover configuration, for example, ten (10) devices can be handed over in the first five (5) seconds, and twenty (20) devices can be handed over in the next five (5) seconds. The first device 110-1 (or the server 140) can reconfigure the individual devices of the group of devices 110 to meet the target handover configuration determined by the third device 130. More generally, based on the third information, the first device 110-1 (or the server 140) may decide how and when the group of devices 110 is to move to the cell 132 of the third device 130.

In some example embodiments, the first device 110-1 (or the server 140) can adjust the movement of the group of devices 110 by reconfiguring the movement pattern of the group of devices 110. For example, in the case that the group of devices 110 include a swarm of UAVs, the swarm may reconfigure its flying pattern (or flying formation) beforehand when crossing from the cell 122 of the second device 120 toward the cell 132 of the third device 130 so as to match the indicated maximum handover rate and other handover parameters. That is, the third information transmitted from the first device 110-1 (or the server 140) to the group of devices 110 may include information for adjusting the group of devices 110 to move based on a movement pattern associated with the target handover configuration.

To this end, the group of devices 110 may be configured with a plurality of movement patterns, and may move according to one of the plurality of movement patterns. For example, if the group of devices 110 is a swarm of UAVs, the swarm of UAVs can move based on one of a plurality of flying patterns. These movement patterns may be pre-configured by users or administrators of the group of devices 110 via the server 140. In this event, each of the plurality of movement patterns may be linked or mapped to a handover configuration, such as a maximum handover rate and other handover parameters supported and accepted by the third device 130.

In other words, the first device 110-1 can obtain associations between the plurality of movement patterns and a plurality of handover configurations. These handover configurations include the target handover configuration determined by the third device 130. Then, the first device 110-1 may select, from the plurality of movement patterns, the movement pattern associated with the target handover configuration based on the associations. In this way, the adjustment of the movement of the group of devices 110 can be simplified, and a complex calculation for a new movement pattern satisfying the target handover configuration can be avoided.

In some example embodiments, the first device 110-1 may transmit an indication of the plurality of movement patterns to the second device 120. For example, the indication may be contained in the first information transmitted from the first device 110-1 to the second device 120. Upon receiving the indication from the first device 110-1, the second device 120 may determine associations between the plurality of movement patterns and the plurality of handover configurations. Afterwards, the second device 120 may transmit an indication of the associations to the first device 110-1. Upon receiving the indication of the associations from the second device 120, the first device 110-1 can thus obtain the associations between the plurality of movement patterns and the plurality of handover configurations.

As such, the mappings between the plurality of movement patterns and the plurality of handover configurations can be configured by the second device 120, thereby reducing the computational burden on the first device 110-1. In some other example embodiments, the indication of the plurality of movement patterns may also be included in the handover request transmitted from the second device 120 to the third device 130, so that the mappings between the plurality of movement patterns and the plurality of handover configurations can be configured by the third device 130.

In some scenarios, it may be not allowed to adjust the movement pattern of the group of devices 110, for example, when the group of devices 110 as a swarm of UAVs is formed to demonstrate a particular image. In this case, the first device 110-1 (or the server 140) can alternatively reduce the speed of the movement of the group of devices 110, to allow all the devices in the group of devices 110 to be successfully handed over to the third device 130, using the target handover configuration acceptable to the third device 130. In other words, the third information transmitted by the first device 110-1 for adjusting the movement of the group of devices 110 may include information for adjusting a movement speed of the group of devices 110.

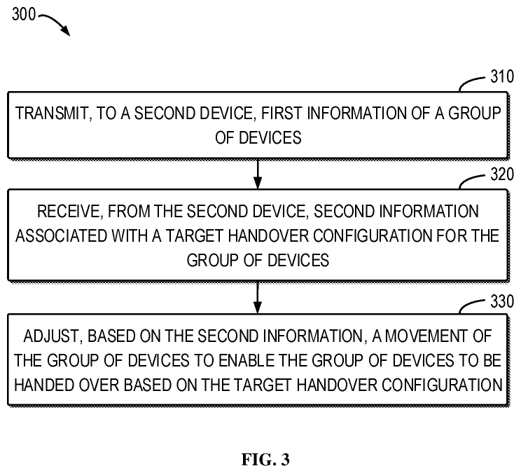

FIG. 3 illustrates a flowchart of an example method 300 in accordance with some example embodiments of the present disclosure. In some example embodiments, the method 300 can be implemented at a device in a communication network, such as the first device 110-1 or the server 140 as shown in FIG. 1. Additionally or alternatively, the method 300 can also be implemented at other devices shown in FIG. 1. In some other example embodiments, the method 300 may be implemented at devices not shown in FIG. 1.

At block 310, a first device transmits, to a second device, first information of the group of devices. At block 320, the first device receives, from the second device, second information associated with a target handover configuration for the group of devices. At block 330, the first device adjusts, based on the second information, a movement of the group of devices to enable the group of devices to be handed over based on the target handover configuration.

In some example embodiments, the second information comprises an indication of the target handover configuration, and the first device is caused to adjust the movement of the group of devices by: transmitting, to at least one of the group of devices, third information for adjusting the group of devices to move based on a movement pattern associated with the target handover configuration.

In some example embodiments, the first device is further caused to: obtain associations between a plurality of movement patterns for the group of devices and a plurality of handover configurations comprising the target handover configuration; and select, from the plurality of movement patterns, the movement pattern associated with the target handover configuration based on the associations.

In some example embodiments, the first device is caused to obtain the associations by: transmitting, to the second device, an indication of the plurality of movement patterns; and receiving, from the second device, an indication of associations between the plurality of movement patterns and the plurality of handover configurations.

In some example embodiments, the third information comprises information for adjusting a movement speed of the group of devices.

In some example embodiments, the first information comprises at least one of the following: the number of devices in the group of devices; a movement speed of a device in the group of devices; a movement direction of a device in the group of devices; a quality of service, QoS, requirement, a degraded QoS requirement, or a lowest QoS requirement of a device in the group of devices; a total QoS requirement, a degraded total QoS requirement, or a lowest total QoS requirement of the group of devices; an identifier of a communication link between a device in the group of devices and the second device; or a configuration of the communication link.

In some example embodiments, the target handover configuration indicates the number of devices to be handed over within a predefined time interval with an acceptable QoS.

In some example embodiments, the second information comprises adjusting information to adjust a movement of the first device based on the target handover configuration, and the first device is caused to adjust the movement of the group of devices by adjusting a movement of the first device.

In some example embodiments, the first device is one of the group of devices or a server for controlling the movement of the group of devices.

In some example embodiments, the group of devices comprises a swarm of unmanned aerial vehicles.

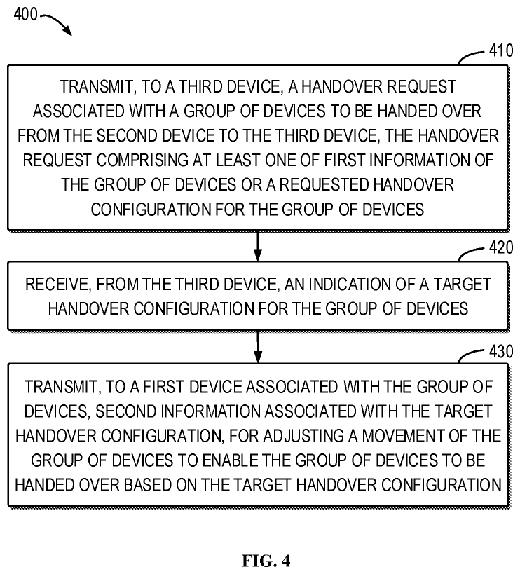

FIG. 4 illustrates a flowchart of another example method 400 in accordance with some example embodiments of the present disclosure. In some example embodiments, the method 400 can be implemented at a device in a communication network, such as the second device 120 as shown in FIG. 1. Additionally or alternatively, the method 400 can also be implemented at other devices shown in FIG. 1. In some other example embodiments, the method 400 may be implemented at devices not shown in FIG. 1.

At block 410, the second device transmits, to the third device, a handover request associated with a group of devices to be handed over from the second device to the third device. The handover request comprises at least one of first information of the group of devices or a requested handover configuration for the group of devices. At block 420, the second device receives, from the third device, an indication of a target handover configuration for the group of devices. At block 430, the second device transmits, to the first device associated with the group of devices, second information associated with the target handover configuration, for adjusting a movement of the group of devices to enable the group of devices to be handed over based on the target handover configuration.

In some example embodiments, the indication comprises at least one of: an acknowledgement indication indicating that the requested handover as indicated by the information of the group of devices and/or the requested handover configuration is accepted by the third device as the target handover configuration; or an explicit indication of the target handover configuration for the group of devices.

In some example embodiments, the second device is caused to receive the indication by: receiving, from the third device, a plurality of indications of a plurality of handover configurations supported by the third device at different time points; and selecting, from the plurality of indications, the indication of a handover configuration supported by the third device at a latest one of the different time points, as the indication of the target handover configuration.

In some example embodiments, the second device is caused to transmit the second information by: transmitting adjusting information to adjust a movement of the first device based on the target handover configuration, the first device being one of the group of devices; or transmitting an indication of the target handover configuration such that the first device adjusts the movement of the group of devices, the first device being one of the group of devices or a server for controlling the movement of the group of devices.

In some example embodiments, the second device is further caused to: receive, from the first device, an indication of a plurality of movement patterns for the group of devices; determine associations between the plurality of movement patterns and a plurality of handover configurations comprising the target handover configuration; and transmit, to the first device, an indication of the associations.

In some example embodiments, the second device is further caused to: receive first information of the group of devices from the first device.

In some example embodiments, the second device is further caused to: predict, based on the first information, a movement path to be travelled by the group of devices; and determine, based on the predicted movement path, the third device to which the group of devices is to be handed over.

In some example embodiments, the second device is further caused to: determine the requested handover configuration based on the first information.

In some example embodiments, the first information comprises at least one of the following: the number of devices in the group of devices; a movement speed of a device in the group of devices; a movement direction of a device in the group of devices; a QoS requirement, a degraded QoS requirement, or a lowest QoS requirement of a device in the group of devices; a total QoS requirement, a degraded total QoS requirement, or a lowest total QoS requirement of the group of devices; an identifier of a communication link between a device in the group of devices and the second device; or a configuration of the communication link.

In some example embodiments, the target handover configuration indicates the number of devices to be handed over within a predefined time interval with an acceptable QoS.

In some example embodiments, the group of devices comprises a swarm of unmanned aerial vehicles.

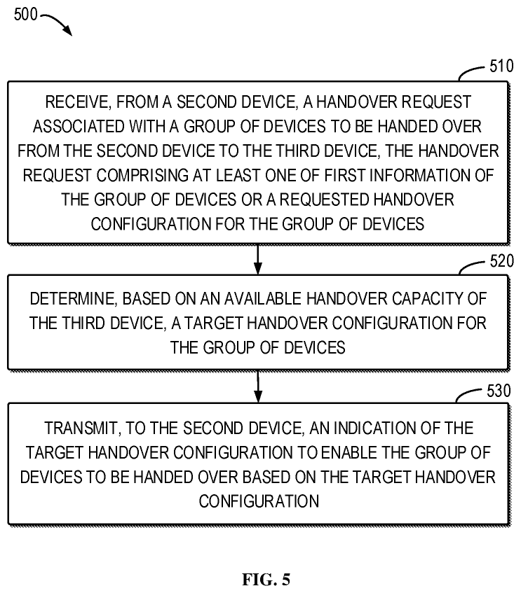

FIG. 5 illustrates a flowchart of another example method 500 in accordance with some example embodiments of the present disclosure. In some example embodiments, the method 500 can be implemented at a device in a communication network, such as the third device 130 as shown in FIG. 1. Additionally or alternatively, the method 500 can also be implemented at other devices shown in FIG. 1. In some other example embodiments, the method 500 may be implemented at devices not shown in FIG. 1.

At block 510, a third device receives, from a second device, a handover request associated with a group of devices to be handed over from the second device to the third device. The handover request comprises at least one of first information of the group of devices or a requested handover configuration for the group of devices. At block 520, the third device determines, based on an available handover capacity of the third device, a target handover configuration for the group of devices. At block 530, the third device transmits, to the second device, an indication of the target handover configuration to enable the group of devices to be handed over based on the target handover configuration.

In some example embodiments, the third device is caused to transmit the indication by: in response to being able to fulfil the requested handover as indicated by the first information of the group of devices and/or the requested handover configuration, transmitting an acknowledge indication indicating that the requested handover is accepted by the third device; and in response to being unable to fulfil the requested handover as indicated by the first information of the group of devices and/or the requested handover configuration, transmitting an explicit indication of the target handover configuration.

In some example embodiments, the third device is caused to transmit the indication by: transmitting, to the second device, a plurality of indications comprising the indication, the plurality of indications of a plurality of handover configurations supported by the third device at different time points.

In some example embodiments, the target handover configuration indicates the number of devices to be handed over within a predefined time interval with an acceptable QoS.

In some example embodiments, the group of devices comprises a swarm of unmanned aerial vehicles.

In some example embodiments, an apparatus capable of performing the method 300 (for example, the first device 110-1 or the server 140) may comprise means for performing the respective steps of the method 300. The means may be implemented in any suitable form. For example, the means may be implemented in a circuitry or software module.

In some example embodiments, the apparatus comprises means for transmitting, at a first device to a second device, first information of a group of devices. The apparatus also comprises means for receiving, from the second device, second information associated with a target handover configuration for the group of devices. The apparatus further comprises means for adjusting, based on the second information, a movement of the group of devices to enable the group of devices to be handed over based on the target handover configuration.

In some example embodiments, the second information comprises an indication of the target handover configuration, and the means for adjusting the movement of the group of devices comprises means for transmitting, to at least one of the group of devices, third information for adjusting the group of devices to move based on a movement pattern associated with the target handover configuration.

In some example embodiments, the apparatus further comprises: means for obtaining associations between a plurality of movement patterns for the group of devices and a plurality of handover configurations comprising the target handover configuration; and means for selecting, from the plurality of movement patterns, the movement pattern associated with the target handover configuration based on the associations.

In some example embodiments, the means for obtaining the associations comprises: means for transmitting, to the second device, an indication of the plurality of movement patterns; and means for receiving, from the second device, an indication of associations between the plurality of movement patterns and the plurality of handover configurations.

In some example embodiments, the third information comprises information for adjusting a movement speed of the group of devices.

In some example embodiments, the first information comprises at least one of the following: the number of devices in the group of devices; a movement speed of a device in the group of devices; a movement direction of a device in the group of devices; a quality of service, QoS, requirement, a degraded QoS requirement, or a lowest QoS requirement of a device in the group of devices; a total QoS requirement, a degraded total QoS requirement, or a lowest total QoS requirement of the group of devices; an identifier of a communication link between a device in the group of devices and the second device; or a configuration of the communication link.

In some example embodiments, the target handover configuration indicates the number of devices to be handed over within a predefined time interval with an acceptable QoS.

In some example embodiments, the second information comprises adjusting information to adjust a movement of the first device based on the target handover configuration, and the means for adjusting the movement of the group of devices comprises means for adjusting a movement of the first device.

In some example embodiments, the first device is one of the group of devices or a server for controlling the movement of the group of devices.

In some example embodiments, the group of devices comprises a swarm of unmanned aerial vehicles.

In some example embodiments, an apparatus capable of performing the method 400 (for example, the second device 120) may comprise means for performing the respective steps of the method 400. The means may be implemented in any suitable form. For example, the means may be implemented in a circuitry or software module.

In some example embodiments, the apparatus comprises means for transmitting, at a second device to a third device, a handover request associated with a group of devices to be handed over from the second device to the third device. The handover request comprises at least one of first information of the group of devices or a requested handover configuration for the group of devices. The apparatus also comprises means for receiving, from the third device, an indication of a target handover configuration for the group of devices. The apparatus further comprises means for transmitting, to a first device associated with the group of devices, second information associated with the target handover configuration, for adjusting a movement of the group of devices to enable the group of devices to be handed over based on the target handover configuration.

In some example embodiments, the indication comprises at least one of: an acknowledgement indication indicating that the requested handover as indicated by the information of the group of devices and/or the requested handover configuration is accepted by the third device as the target handover configuration; or an explicit indication of the target handover configuration for the group of devices.

In some example embodiments, the means for receiving the indication comprises: means for receiving, from the third device, a plurality of indications of a plurality of handover configurations supported by the third device at different time points; and means for selecting, from the plurality of indications, the indication of a handover configuration supported by the third device at a latest one of the different time points, as the indication of the target handover configuration.

In some example embodiments, the means for transmitting the second information comprises: means for transmitting adjusting information to adjust a movement of the first device based on the target handover configuration, the first device being one of the group of devices; or means for transmitting an indication of the target handover configuration such that the first device adjusts the movement of the group of devices, the first device being one of the group of devices or a server for controlling the movement of the group of devices.

In some example embodiments, the apparatus further comprises: means for receiving, from the first device, an indication of a plurality of movement patterns for the group of devices; means for determining associations between the plurality of movement patterns and a plurality of handover configurations comprising the target handover configuration; and means for transmitting, to the first device, an indication of the associations.

In some example embodiments, the apparatus further comprises: means for receiving first information of the group of devices from the first device.

In some example embodiments, the apparatus further comprises: means for predicting, based on the first information, a movement path to be travelled by the group of devices; and means for determining, based on the predicted movement path, the third device to which the group of devices is to be handed over.

In some example embodiments, the apparatus further comprises: means for determining the requested handover configuration based on the first information.

In some example embodiments, the first information comprises at least one of the following: the number of devices in the group of devices; a movement speed of a device in the group of devices; a movement direction of a device in the group of devices; a QoS requirement, a degraded QoS requirement, or a lowest QoS requirement of a device in the group of devices; a total QoS requirement, a degraded total QoS requirement, or a lowest total QoS requirement of the group of devices; an identifier of a communication link between a device in the group of devices and the second device; or a configuration of the communication link.

In some example embodiments, the target handover configuration indicates the number of devices to be handed over within a predefined time interval with an acceptable QoS.

In some example embodiments, the group of devices comprises a swarm of unmanned aerial vehicles.

In some example embodiments, an apparatus capable of performing the method 500 (for example, the third device 130) may comprise means for performing the respective steps of the method 500. The means may be implemented in any suitable form. For example, the means may be implemented in a circuitry or software module.

In some example embodiments, the apparatus comprises: means for receiving, at a third device from a second device, a handover request associated with a group of devices to be handed over from the second device to the third device. The handover request comprises at least one of first information of the group of devices or a requested handover configuration for the group of devices. The apparatus also comprises: means for determining, based on an available handover capacity of the third device, a target handover configuration for the group of devices. The apparatus further comprises: means for transmitting, to the second device, an indication of the target handover configuration to enable the group of devices to be handed over based on the target handover configuration.

In some example embodiments, the means for transmitting the indication comprises: means for, in response to being able to fulfil the requested handover as indicated by the first information of the group of devices and/or the requested handover configuration, transmitting an acknowledgement indication indicating that the requested handover is accepted by the third device; and means for, in response to being unable to fulfil the requested handover as indicated by the first information of the group of devices and/or the requested handover configuration, transmitting an explicit indication of the target handover configuration.

In some example embodiments, the means for transmitting the indication comprises: means for transmitting, to the second device, a plurality of indications comprising the indication, the plurality of indications of a plurality of handover configurations supported by the third device at different time points.

In some example embodiments, the target handover configuration indicates the number of devices to be handed over within a predefined time interval with an acceptable QoS.

In some example embodiments, the group of devices comprises a swarm of unmanned aerial vehicles.

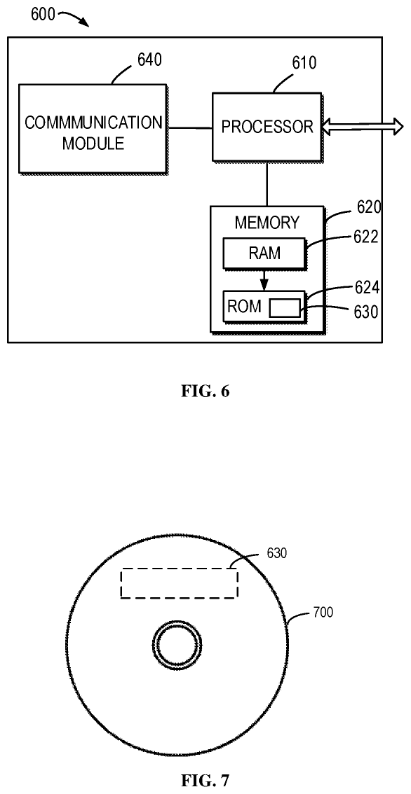

FIG. 6 illustrates a simplified block diagram of a device 600 that is suitable for implementing example embodiments of the present disclosure. The device 600 may be provided to implement a communication device, for example, the group of devices 110 including the first device 110-1, the second device 120, the third device 130, and the server 140 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 may have at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIGS. 2 to 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 illustrates a block diagram of an example computer readable medium 700 in form of CD or DVD, in accordance with some example embodiments of the present disclosure. The computer readable medium has the program 630 stored thereon.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300, 400, and 500 as described above with reference to FIGS. 3-5. Generally, program modules include routines, programs, libraries, objects, classes, components, data structures, or the like that perform particular tasks or implement particular abstract data types. The functionality of the program modules may be combined or split between program modules as desired in various example embodiments.

Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single example embodiment. Conversely, various features that are described in the context of a single example embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one non-transitory memory storing computer program codes;
the at least one memory and the computer program codes being configured, with the at least one processor, to cause the first device to:
transmit, to a second device, first information of a group of devices;
receive, from the second device, second information associated with a target handover configuration for the group of devices; and
adjust, based on the second information, a movement of the group of devices to enable the group of devices to be handed over based on the target handover configuration.

2. The first device of claim 1, wherein the second information comprises an indication of the target handover configuration, and wherein the at least one memory and the computer program codes are configured, with the at least one processor, to cause an adjust of the movement of the group of devices with:
transmitting, to at least one of the group of devices, third information for adjusting the group of devices to move based on a movement pattern associated with the target handover configuration.

3. The first device of claim 2, wherein the at least one memory and the computer program codes are configured, with the at least one processor, to cause the first device to:
obtain associations between a plurality of movement patterns for the group of devices and a plurality of handover configurations comprising the target handover configuration; and
select, from the plurality of movement patterns, the movement pattern associated with the target handover configuration based on the associations.

4. The first device of claim 3, wherein at least one memory and the computer program codes are configured, with the at least one processor, to cause the first device to obtain the associations with:
transmitting, to the second device, an indication of the plurality of movement patterns; and
receiving, from the second device, an indication of associations between the plurality of movement patterns and the plurality of handover configurations.

5. The first device of claim 1, wherein the third information comprises information for adjusting a movement speed of the group of devices.

6. The first device of claim 1, wherein the first information comprises at least one of the following:
the number of devices in the group of devices;
a movement speed of a device in the group of devices;
a movement direction of a device in the group of devices;
a quality of service requirement, a degraded quality of service requirement, or a lowest QoS quality of service requirement of a device in the group of devices;
a total quality of service requirement, a degraded total quality of service requirement, or a lowest total quality of service requirement of the group of devices;
an identifier of a communication link between a device in the group of devices and the second device; or
a configuration of the communication link.

7. The first device of claim 1, wherein the target handover configuration indicates the number of devices to be handed over within a predefined time interval with an acceptable quality of service.

8. The first device of claim 1, wherein the second information comprises adjusting information to adjust a movement of the first device based on the target handover configuration, and the at least one memory and the computer program codes are configured, with the at least one processor, to cause the first device to adjust the movement of the group of devices with adjusting the movement of the first device.

9. The first device of claim 1, wherein the first device is one of the group of devices or a server for controlling the movement of the group of devices.

10. The first device of claim 1, wherein the group of devices comprises a swarm of unmanned aerial vehicles.

11. A second device, comprising:
at least one processor; and
at least one non-transitory memory storing computer program codes;
the at least one memory and the computer program codes being configured, with the at least one processor, to cause the second device to:
transmit, to a third device, a handover request associated with a group of devices to be handed over from the second device to the third device, the handover request comprising at least one of first information of the group of devices or a requested handover configuration for the group of devices;
receive, from the third device, an indication of a target handover configuration for the group of devices; and
transmit, to a first device associated with the group of devices, second information associated with the target handover configuration, for adjusting a movement of the group of devices to enable the group of devices to be handed over based on the target handover configuration.

12. The second device of claim 11, wherein the indication comprises at least one of:
an acknowledgement indication indicating that the requested handover as indicated with the information of the group of devices and/or requested handover configuration is accepted with the third device as the target handover configuration; or
an explicit indication of the target handover configuration for the group of devices.

13. The second device of claim 11, wherein the at least one memory and the computer program codes are configured, with the at least one processor, to cause the second device to receive the indication with:
receiving, from the third device, a plurality of indications of a plurality of handover configurations supported with the third device at different time points; and
selecting, from the plurality of indications, the indication of a handover configuration supported with the third device at a latest one of the different time points, as the indication of the target handover configuration.

14. The second device of claim 11, wherein the at least one memory and the computer program codes are configured, with the at least one processor, to cause the second device to transmit the second information with:
transmitting adjusting information to adjust a movement of the first device based on the target handover configuration, the first device being one of the group of devices; or
transmitting an indication of the target handover configuration such that the first device adjusts the movement of the group of devices, the first device being one of the group of devices or a server for controlling the movement of the group of devices.

15. The second device of claim 11, wherein the at least one memory and the computer program codes are configured, with the at least one processor, to cause the second device to:
receive, from the first device, an indication of a plurality of movement patterns for the group of devices;
determine associations between the plurality of movement patterns and a plurality of handover configurations comprising the target handover configuration; and
transmit, to the first device, an indication of the associations.

16. The second device of claim 11, wherein the at least one memory and the computer program codes are configured, with the at least one processor, to cause the second device to:
receive first information of the group of devices from the first device.

17. The second device of claim 16, wherein the at least one memory and the computer program codes are configured, with the at least one processor, to cause the second device to:
predict, based on the first information, a movement path to be travelled by the group of devices; and
determine, based on the predicted movement path, the third device to which the group of devices is to be handed over.

18. The second device of claim 16, wherein the at least one memory and the computer program codes are configured, with the at least one processor, to cause the second device to:
determine the requested handover configuration based on the first information.

19. The second device of claim 16, wherein the first information comprises at least one of the following:
the number of devices in the group of devices; a movement speed of a device in the group of devices;
a movement direction of a device in the group of devices;
a quality of service requirement, a degraded quality of service requirement, or a lowest quality of service requirement of a device in the group of devices;
a total quality of service requirement, a degraded total quality of service requirement, or a lowest total quality of service requirement of the group of devices;
an identifier of a communication link between a device in the group of devices and the second device; or
a configuration of the communication link.

20.-21. (canceled)

22. A third device, comprising:
at least one processor; and
at least one non-transitory memory storing computer program codes;
the at least one memory and the computer program codes being configured, with the at least one processor, to cause the third device to:
receive, from a second device, a handover request associated with a group of devices to be handed over from the second device to the third device, the handover request comprising at least one of first information of the group of devices or a requested handover configuration for the group of devices;
determine, based on an available handover capacity of the third device, a target handover configuration for the group of devices; and
transmit, to the second device, an indication of the target handover configuration to enable the group of devices to be handed over based on the target handover configuration.

23. The third device of claim 22, wherein the at least one memory and the computer program codes are configured, with the at least one processor, to cause the third device to transmit the indication with:
in response to being able to fulfil the requested handover as indicated with the first information of the group of devices and/or the requested handover configuration, transmitting an acknowledgement indication indicating that the requested handover configuration is accepted with the third device; and
in response to being unable to fulfil the requested handover as indicated with the first information of the group of devices and/or the requested handover configuration, transmitting an explicit indication of the target handover configuration.

24.-33. (canceled)
